(19) United States
(12) Patent Application Publication
(10) Pub. No.: US 2025/0364565 A1
(43) Pub. Date: Nov. 27, 2025

(54) CATHODE FOR LITHIUM METAL SECONDARY BATTERY, METHOD OF MANUFACTURING THE SAME, AND LITHIUM METAL SECONDARY BATTERY COMPRISING THE SAME

(71) Applicants: Hyundai Motor Company, Seoul (KR); Kia Corporation, Seoul (KR)

(72) Inventors: Jaekeun Nam, Hwaseong (KR); Won Keun Kim, Hwaseong (KR); Jungyeob Do, Hwaseong (KR); Kyoung Han Ryu, Hwaseong (KR); Jae Wook Shin, Hwaseong (KR)

(21) Appl. No.: 19/214,651

(22) Filed: May 21, 2025

(30) Foreign Application Priority Data
May 23, 2024 (KR) 10-2024-0066968

(51) Int. Cl. H01M 4/62; H01M 4/02; H01M 4/04; H01M 4/525; H01M 10/0525

(52) U.S. Cl. CPC H01M 4/628; H01M 2004/021; H01M 4/0404; H01M 4/0435; H01M 4/525; H01M 4/625; H01M 10/0525; H01M 2220/20

(57) ABSTRACT

Provided is a positive electrode for a lithium metal rechargeable battery, comprising: a current collector; a positive electrode active material layer formed on the current collector; and a polymer-containing coating layer disposed on the positive electrode active material layer; wherein the polymer-containing coating layer comprises an ion-conductive polymer including an alkylene oxide segment. The resulting battery, when paired with a lithium metal negative electrode and separator, offers enhanced mechanical stability and improved cycle performance, making it suitable for vehicle applications.

### CROSS-REFERENCE TO RELATED APPLICATION

This application claims under 35 U.S.C. § 119(a) the benefit of Korean Patent Application No. 10-2024-0066968 filed in the Korean Intellectual Property Office on May 23, 2024, the entire contents of which are incorporated herein by reference.

### BACKGROUND

### Technical Field

The present disclosure relates to a positive electrode for a lithium metal rechargeable battery, a manufacturing method thereof, and a lithium metal rechargeable battery including the same, and more specifically, to a positive electrode for a lithium metal rechargeable battery including a positive electrode active material layer coating layer, a manufacturing method thereof, and a lithium metal rechargeable battery including the same.

### Background

As technological developments and demand for mobile devices increase, the demand for rechargeable batteries as an energy source is also rapidly increasing. Among rechargeable batteries, lithium rechargeable batteries, which exhibit high energy density and operation potential, long cycle span, and low self-discharge rate, are commercially available and widely used.

Lithium rechargeable batteries have mainly been made using carbon-based or non-carbon-based negative electrode materials, and most negative electrode material development has focused on carbon-based (graphite, hard carbon, soft carbon, etc.) and non-carbon-based (silicon, tin, titanium oxide, etc.) materials. However, carbon-based materials have a theoretical capacity of less than 400 mAh/g, and non-carbon-based materials have a theoretical capacity of more than 1,000 mAh/g, but they suffer from volume expansion and performance deterioration during charging and discharging.

Meanwhile, with the recent activation of medium-and large-sized lithium rechargeable batteries, high-capacity and a high energy density characteristic are required, but existing carbon-based or non-carbon-based negative electrode materials have limitations in meeting such performance.

Accordingly, interest in lithium metal rechargeable batteries that have the potential to achieve excellent energy density with a theoretical capacity exceeding 3,800 mAh/g is growing again. Lithium metal rechargeable batteries were the first commercially available lithium rechargeable battery and use lithium metal as the negative electrode.

However, unlike lithium rechargeable batteries, lithium metal rechargeable batteries use electrolytes containing high concentrations of salts, which actively react with the positive electrode active material with high nickel content, inducing shrinkage and expansion of the crystal and generating residues between particles. In addition, as the cycle progresses, this reaction becomes more accelerated, causing particle breakage of the positive electrode active material, a problem that is particularly aggravated in the upper part of the electrode close to the negative electrode.

Accordingly, to secure the cycle characteristics and stability performance of lithium metal batteries, it is necessary to develop a positive electrode for lithium metal rechargeable batteries that incorporates new components.

### SUMMARY OF THE DISCLOSURE

The present disclosure provides a positive electrode for a lithium metal battery, wherein a coating layer formed on a positive electrode surface prevents the reaction between an electrolyte containing a high concentration of salt and a positive electrode active material, thereby reducing breakage of the positive electrode active material and residue generation, thereby improving the positive electrode characteristics and enhancing the capacity characteristic of a lithium metal rechargeable battery; a method for manufacturing the same; and a lithium metal battery including the same.

Some embodiments includes a current collector; a positive electrode active material layer formed on the current collector; and a polymer-containing coating layer disposed on the positive electrode active material layer; wherein the polymer-containing coating layer includes an ion-conductive polymer including an alkylene oxide segment.

The content of the ion-conductive polymer may be 0.5 to 20 wt % with the entire 100 wt % reference of the positive electrode active material layer.

The ion-conductive polymer may be at least one selected from polyethylene oxide, polypropylene oxide, polybutylene oxide, a polyethylene oxide-polypropylene oxide blend, a polyethylene oxide-polybutylene oxide blend, a polyethylene oxide-polypropylene oxide-polybutylene oxide block copolymer, and polyethylene oxide grafted polymethylmethacrylate (PEO grafted PMMA).

The ion-conductive polymer may be polyethylene oxide.

The weight average molecular weight (Mw) of the ion-conductive polymer may be 50,000 to 100,000 Da.

The positive electrode active material layer may include a positive electrode active material, a conductive material, and a binder.

The positive electrode active material layer may include a positive electrode active material represented by the following Chemical Formula 1.

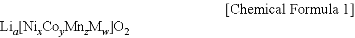

In the above formula 1, 0.8≤a≤1.2, 0<x<1, 0≤y≤1, 0≤z≤1, 0≤w≤1, and x+y+z+W=1, and M is Zr, Al, B, Y, Mg, Ti, Nb, W, Sc, Si, V, Fe, Y, Mo, Ce, Hf, Ta, La, Sr or combination thereof.

The positive electrode active material may be 80 to 99 wt %, based on the total weight (100 wt %) of the positive electrode active material layer.

The conductive material may be 0.5 to 5.0 wt %, based on the total weight (100 wt %) of the positive electrode active material layer.

The conductive material may include one or more selected from graphite, carbon black, acetylene black, and carbon nanotubes.

The binder may be 0.5 to 5.0 wt %, based on the total weight (100 wt %) of the positive electrode active material layer.

The porosity of the positive electrode may be 20 to 40%.

Another embodiment of the present disclosure comprises the steps of preparing a coating solution; applying the coating solution on a positive electrode active material layer; drying; and rolling;

The coating solution comprises an ion-conductive polymer including an alkylene oxide segment.

The content of polyethylene oxide, which is an ion-conductive polymer, in the coating solution may be 2 to 6 wt %.

The solvent in the coating solution may include one or more selected from methyl pyrrolidone, dimethyl formamide, ethanol, acetone, diethyl ether or ethyl acetate.

The step of applying a coating solution on the positive electrode active material layer may be applied using a bar coater.

The drying temperature of the drying step may be 70 to 130° C.

The rolling density of the rolling step may be 2.0 to 4.0 g/cc.

Another embodiment of the present disclosure comprises a positive electrode for a lithium metal rechargeable battery as described above.

According to some embodiments, a positive electrode for a lithium metal rechargeable battery forms a coating layer including an ion-conductive polymer on the upper portion of the positive electrode, thereby preventing the reaction between an electrolyte including a high concentration of salt and a positive electrode active material, while improving the increase in resistance of the positive electrode due to breakage and reaction of the positive electrode active material, and further improving the capacity characteristics of the lithium metal rechargeable battery by not hindering lithium movement.

As discussed, the method and system suitably include use of a controller or processer.

In another embodiment, vehicles are provided that comprise an apparatus as disclosed herein.

### BRIEF DESCRIPTION OF THE DRAWINGS

FIG. 1 shows the life-span characteristic evaluation results of the lithium metal rechargeable batteries manufactured in Embodiments 1 to 4 and Comparative Examples 1 to 5.

FIG. 2 is a scanning electron microscope (SEM) image of the initial state of the surface of the positive electrode for a lithium metal rechargeable battery manufactured in embodiment 1.

FIG. 3 is a scanning electron microscope (SEM) image of the initial state of the surface of the positive electrode for a lithium metal rechargeable battery manufactured in embodiment 2.

FIG. 4 shows a scanning electron microscope (SEM) image of the positive electrode surface at the end-of-life (EOL) state in a lithium metal rechargeable battery fabricated according to Embodiment 2.

FIG. 5 is a scanning electron microscope (SEM) image of the initial state of the positive electrode surface for the lithium metal rechargeable battery manufactured in Comparative Example 1.

FIG. 6 is a scanning electron microscope (SEM) image of the EOL (End Of Life) state of the positive electrode surface for the lithium metal rechargeable battery manufactured in Comparative Example 1.

FIG. 7 is a scanning electron microscope (SEM) image of the EOL (End Of Life) state of the positive electrode surface for the lithium metal rechargeable battery manufactured in Comparative Example 2.

FIG. 8 is a scanning electron microscope (SEM) image of the initial state of the positive electrode surface for the lithium metal rechargeable battery manufactured in Comparative Example 4.

FIG. 9 is a scanning electron microscope (SEM) image of the end-of-life (EOL) state of the positive electrode surface for the lithium metal rechargeable battery manufactured in Comparative Example 4.

FIG. 10 is a scanning electron microscope (SEM) image of the initial state of the positive electrode surface for the lithium metal rechargeable battery manufactured in Comparative Example 6.

### DETAILED DESCRIPTION OF THE EMBODIMENTS

Terms such as first, second and third are used to describe, but are not limited to, the various parts, components, region, layers and/or sections. These terms are used only to distinguish one part, component, region, layer, or section from another part, component, area, layer, or section. Accordingly, a first part, component, region, layer or section described herein may be referred to as a second part, component, region, layer or section without departing from the scope of the present disclosure.

The technical terms used herein are intended to refer only to certain exemplary embodiments and are not intended to limit the present disclosure. The singular forms used here include plural forms unless the context clearly indicates the opposite. The meaning of “comprising/including/having/containing” as used in a specification is to specify a particular characteristic, region, integer, step, behavior, element, and/or component, and does not exclude the existence or add any other characteristic, region, integer, step, behavior, element, and/or component.

The term “alkylene oxide segment” as used herein refers to a polymer unit (e.g. polymer repeating unit) that can be derived from an alkylene oxide, for example ethylene oxide or propylene oxide. Exemplary alkylene oxides include, for example, ethylene oxide, 1,2-propylene oxide, 2,3-propylene oxide, 1,2-butane oxide, 2-methyl-1,2-butaneoxide, 2,3-butane oxide, tetrahydrofuran, epichlorohydrin, hexane oxide, a glycidyl ether such as Bisphenol A diglycidyl ether, or other polymerizable oxirane. In aspects, C₂-C₁₆-alkylene oxides may be preferred. Alkylene oxides also have been characterized as cyclic ethers with the general formula (CH2)n—O(CH2)n, where each n is the same or different positive integer.

The term “binder” as used herein refers to a polymeric material that helps adhere active-material particles and conductive additives together and binds them to the current collector.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

When we say that a part is “on” or “above” another part, it may be directly on or above the other part, or it may entail another part in between. In contrast, when we say that something is “directly on” of something else, we don't interpose anything between them.

Unless otherwise defined, all terms used herein, including technical and scientific terms, have the same meaning as commonly understood by a person of ordinary skill in the technical field to which the present disclosure belongs. Commonly used dictionary-defined terms are further construed to have meanings consistent with the relevant technical literature and the present disclosure and are not to be construed in an idealized or highly formal sense unless defined.

Also, unless otherwise noted, “%” refers to “wt %”, where 1 ppm is 0.0001 wt %.

In this specification, the term “combination thereof(s)” described in a Markush format expression means one or more mixtures or combinations selected from the group consisting of components described in the Markush format expression and means including one or more selected from the group consisting of the components.

### 1. Positive Electrode for Lithium Metal Rechargeable Battery

According to some embodiments, a positive electrode for a lithium metal rechargeable battery includes: a current collector; a positive electrode active material layer formed on the current collector; and a polymer-containing coating layer on the positive electrode active material layer; wherein, the polymer-containing coating layer includes an ion-conductive polymer including an alkylene oxide-based segment.

In a positive electrode for a lithium metal rechargeable battery according to some embodiments, the content of the ion-conductive polymer can be 0.5 to 20 wt %, preferably 1 to 10 wt %, and more preferably 2 to 5 wt %, with the entire 100 wt % reference to the positive electrode active material layer. When the content of the ion-conductive polymer satisfies the range, a dense thin film is formed on the top of the positive electrode, which can suppress particle breakage of the positive electrode active material and suppress the reaction with the electrolyte containing a high concentration of salt without interfering with lithium movement. On the other hand, if the content of the ion-conductive polymer is out of the range, the lithium mobility at the positive electrode interface may decrease, the adhesive strength of the binder may be weakened, and the resistance of the positive electrode may be significantly degraded.

In a positive electrode for a lithium metal rechargeable battery according to some embodiments, the ion-conductive polymer may be at least one selected from polyethylene oxide, polypropylene oxide, polybutylene oxide, a polyethylene oxide-polypropylene oxide blend, a polyethylene oxide-polybutylene oxide blend, a polyethylene oxide-polypropylene oxide-polybutylene oxide block copolymer, and polyethylene oxide-grafted polymethylmethacrylate (PEO grafted PMMA), but is not limited thereto, and any polymer including an alkylene oxide segment can be used as the ion-conductive polymer.

In a positive electrode for a lithium metal rechargeable battery according to some embodiments, the ion-conductive polymer may be polyethylene oxide.

In a positive electrode for a lithium metal rechargeable battery according to some embodiments, the weight average molecular weight (Mw) of the ion-conductive polymer may be 50,000 to 100,000 Da, specifically 55,000 to 95,000 Da, more specifically 60,000 to 90,000 Da. If the weight average molecular weight (Mw) of the ion-conductive polymer satisfies the range, it can have an appropriate chain length, i.e., polymerization degree, so that the ion conductivity can be improved at room temperature. However, the weight average molecular weight (Mw) of the ion-conductive polymer is not limited to the range, and the entire range in which ion conductivity is improved in a lithium metal rechargeable battery can be used.

In a positive electrode for a lithium metal battery according to some embodiments, the positive electrode active material layer may include a positive electrode active material, a conductive material, and a binder.

In a positive electrode for a lithium metal rechargeable battery according to some embodiments, the positive electrode active material layer may include a positive electrode active material represented by the following Chemical Formula 1.

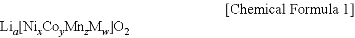

In the above formula 1, 0.8≤a≤1.2, 0<x<1, 0≤y≤1, 0≤z≤1, 0≤w≤1, and X+y+Z+W=1, and M is Zr, Al, B, Y, Mg, Ti, Nb, W, Sc, Si, V, Fe, Y, Mo, Ce, Hf, Ta, La, Sr or combination thereof.

In the lithium metal oxide of the above formula 1, lithium can be included in a content corresponding to a, that is, 0.8≤a≤1.2. If a is too small, capacity deterioration may occur, and if a is too large, the strength of the sintered positive electrode active material may increase, making pulverization difficult, and the amount of gas generated may increase due to an increase in lithium byproducts. Considering the effect of improving the capacity characteristics of the positive electrode active material according to the lithium content control and the balance of sintering properties during the manufacturing of the active material, the lithium can be included in a content of preferably 0.9≤a≤ 1.1.

In the lithium metal oxide of the above formula 1, nickel can be included in a content corresponding to x, that is, 0.8≤x<1 or 0.85≤x<1, 0.90≤x<1, 0.94≤x<1. If the nickel content is too low, it may be difficult to achieve high capacity of the battery, and if the nickel content is too high, the battery life-span and thermal stability may decrease due to active material structural stability deterioration, and the manufacturing cost may increase.

In the lithium metal oxide of the above formula 1, the content corresponding to cobalt y can be included, that is, 0≤y≤0.2 or 0.01≤y≤0.1. If the cobalt content is too low, it may be difficult to simultaneously achieve sufficient rate characteristics and high powder density of the active material. Too much cobalt content may increase the overall cost of the raw material and reduce the reversible capacity.

In the lithium metal oxide of the above formula 1, the content corresponding to manganese z can be included as 0≤z≤0.2 or 0.1≤z≤0.1. If the manganese content is too low, production costs may increase, and active material stability may decrease. If the manganese content is too high, the battery's capacity and output characteristics may decrease.

In the lithium metal oxide of the above formula 1, M can be included in a content corresponding to w, that is, 0≤w≤0.2 or 0≤w≤0.1. At this time, M is a doping element, which may be Zr, Al, B, Y, Mg, Ti, Nb, W, Sc, Si, V, Fe, Y, Mo, Ce, Hf, Ta, La, Sr or a combination thereof, but is not limited thereto, and any metal that can be used as a doping element in the positive electrode active material may be possible.

In a positive electrode for a lithium metal rechargeable battery according to some embodiments, the content of the positive electrode active material can be 80 to 99 wt %, and preferably 90 to 99 wt %, with respect to the entire 100 wt % of the positive electrode active material layer. When the content of the positive electrode active material satisfies the range, low electrode resistance and high energy density can be achieved. On the other hand, if the content of the positive electrode active material is out of the range, the electrode resistance may increase due to the high binder content.

In a positive electrode for a lithium metal rechargeable battery according to some embodiments, the content of the conductive material can be 0.5 to 5.0 wt %, preferably 1.0 to 4.5 wt %, and more preferably 1.5 to 4.0 wt %, with respect to the entire 100 wt % of the positive electrode active material layer. When the content of the conductive material satisfies the range, the electric characteristics can be improved by promoting the movement of electrons between the positive electrode active material and the negative electrode active material. On the other hand, if the content of the conductive material is out of the range, the capacity of the battery may decrease and the high-rate discharge characteristics (high-rate charge/discharge characteristics, high-rate charge/discharge efficiency) and the initial charge/discharge efficiency may also be adversely affected.

In a positive electrode for a lithium metal rechargeable battery according to some embodiments, the conductive material may include, but is not limited to, one or more selected from graphite, carbon black, acetylene black, and carbon nanotube, and any conductive material that does not cause a chemical change in the positive electrode for a lithium metal battery and has electron conductivity may be used.

In a positive electrode for a lithium metal rechargeable battery according to some embodiments, the content of the binder may be 0.5 to 5.0 wt %, preferably 1.0 to 4.5 wt %, and more preferably 1.5 to 4.0 wt %, with respect to the entire 100 wt % of the positive electrode active material layer. When the content of the binder satisfies the range, the adhesion between positive electrode active material particles and the adhesive strength between the positive electrode active material and the current collector can be improved.

In a positive electrode for a lithium metal rechargeable battery according to some embodiments, binders such as polyethylene, polypropylene, polytetrafluoro ethylene (PTFE), polyvinylidene fluoride (PVDF), styrene-butadiene rubber, tetrafluoroethylene-perfluoroalkylvinyl ether copolymer, fluorinated vinylidene-hexafluoropropylene copolymer, fluorinated vinylidene-chlorotrifluoroethylene copolymer, ethylene-tetrafluoroethylene copolymer, polychlorotrifluoroethylene, fluorinated vinylidene pentafluoro propylene copolymer, propylene-tetrafluoroethylene copolymer, ethylene-chlorotrifluoroethylene copolymer, fluorinated vinylidene-hexafluoropropylene-tetrafluoroethylene copolymer, fluorinated vinylidene-perfluoromethylvinyl ether-tetrafluoro ethylene copolymer, and ethylene-acrylate copolymer may be used alone or in combination, but are not necessarily limited thereto, and any binder that can be used in the relevant technical field may be used.

The active layer may additionally include other components in addition to the positive electrode active material, conductive material, and binder. Additional components that can be added to the active layer may include a cross-linking agent or a conductive material dispersant. The cross-linking agent may be a cross-linking agent having two or more functional groups capable of reacting with the cross-linking functional groups of the acryl-based polymer to cause the binder to form a cross-linking network. The cross-linking agent is not particularly limited, but may be selected from an isocyanate cross-linking agent, an epoxy cross-linking agent, an aziridine cross-linking agent, or a metal chelate cross-linking agent. Additionally, the conductive material dispersant can help distribute the non-polar carbon-based conductive material to form a paste. The conductive material dispersant is not particularly limited but may be selected from cellulose-based compounds including carboxymethyl cellulose (CMC), starch, hydroxypropyl cellulose, and regenerated cellulose.

In a positive electrode for a lithium metal rechargeable battery according to some embodiments, the porosity of the positive electrode can be 20 to 40%, preferably 22 to 30%, more preferably 23 to 28%. When the porosity of the positive electrode satisfies the range, the energy density of the battery, the electrical conductivity of the electrode, and the ionic conductivity can be improved. On the other hand, if the porosity of the positive electrode is out of the range, the filling density of the positive electrode active material may decrease, making it difficult to implement a high energy density.

### 2. Method of Manufacturing a Positive Electrode for Lithium Metal Rechargeable Battery

A positive electrode manufacturing method for a lithium metal rechargeable battery according to another embodiment of the present disclosure comprises the steps of: preparing a coating solution; applying the coating solution on a positive electrode active material layer; drying; and rolling, wherein the coating solution comprises an ion-conductive polymer including an alkylene oxide segment.

In a positive electrode manufacturing method for a lithium metal rechargeable battery according to another embodiment of the present disclosure, the content of polyethylene oxide, which is an ion-conductive polymer, in the coating solution may be comprised of 2 to 6 wt % and preferably comprised of 2 to 5 wt %. When the content of polyethylene oxide satisfies the range, a dense thin film is formed on the top of the positive electrode, thereby suppressing particle breakage of the positive electrode active material, and the reaction with the electrolyte containing a high concentration of salt is also suppressed, so that lithium movement is not hindered, and the durability improvement effect can be obtained. On the other hand, if the content of polyethylene oxide is out of the range, the problem of polyethylene oxide reducing lithium mobility at the interface and degrading the resistance or adhesive strength of the positive electrode may occur.

In a method for manufacturing a positive electrode for a lithium metal rechargeable battery according to another embodiment of the present disclosure, the solvent in the coating solution may include, but is not limited to, one or more selected from methylpyrrolidone, dimethyl formamide, ethanol, acetone, diethyl ether or ethyl acetate, and any solvent that can be used as a coating solution may be used.

In a positive electrode manufacturing method for a lithium metal rechargeable battery according to another embodiment of the present disclosure, a step of applying a coating solution on the positive electrode active material layer may be applied by a bar coater, but is not limited thereto, and methods capable of applying the coating solution on the positive electrode active material layer, for example, a screen coating method, a doctor blade method, a dip method, a reverse roll method, a direct roll method, a gravure method, or an extrusion method, may be applied.

In a positive electrode manufacturing method for a lithium metal rechargeable battery according to another embodiment of the present disclosure, the drying temperature of the drying step may be 70 to 130° C., but the drying temperature range may change depending on the type and content of the active material, binder or conductive material used in the electrode. When the drying temperature satisfies the range, not only can the adhesive strength with an electrode be improved, but also the battery performance can be improved by reducing the amount of moisture remaining in the electrode. On the other hand, if the drying temperature exceeds the range, the formation of microcrystals is triggered, which causes the electrode to harden, and the electrode itself may easily break during the battery assembly process, resulting in rapid deterioration of the battery capacity or failure to operate as a battery. In addition, if the drying temperature is below the range, a problem may occur in which the active material formed on the electrode expands significantly during charging and discharging.

In a positive electrode manufacturing method for a lithium metal rechargeable battery according to another embodiment of the present disclosure, the rolling density of the rolling step can be 2.0 to 4.0 g/cc, preferably 2.5 to 3.5 g/cc, and more preferably 2.8 to 3.2 g/cc. When the rolling density satisfies the range, the energy density per volume can be increased when applied to a battery. On the other hand, if the rolling density is out of the range, the contact between the active materials may not be sufficient and the porosity may increase, which may increase the resistance.

### 3. Lithium Metal Rechargeable Battery

According to another embodiment of the present disclosure, a lithium metal rechargeable battery is provided, which comprises a positive electrode for the lithium metal rechargeable battery as described above.

The lithium metal rechargeable battery further includes a separator positioned between the positive electrode and the lithium metal negative electrode for the aforementioned lithium metal rechargeable battery; and an electrolyte may be impregnated into the separator. Such a structure can be formed by a method generally known in the art, wherein the electrode assembly is manufactured using the positive electrode and the aforementioned lithium metal for lithium metal rechargeable battery, with a separator interposed therebetween, the electrode assembly is embedded in a battery case, and an electrolyte is injected into the separator.

By the electrolyte injected into the separator, the lithium metal negative electrode can be activated by discharging and then charging while it is sufficiently wet.

Meanwhile, in the lithium metal rechargeable battery of the embodiment, components other than the positive electrode coating layer and the positive electrode including the same may be adopted as those generally known in the art.

The lithium metal negative electrode can be manufactured by depositing lithium metal on one or both sides of a planar negative electrode current collector or by rolling lithium foil. At this time, the negative electrode current collector may be specifically copper foil.

The copper foil can generally be made with a thickness of 3 to 100 micrometers, and the lithium metal formed on the copper foil can be formed with a thickness of, for example, 1 to 300 micrometers. Alternatively, a negative electrode made solely of lithium metal can be used.

The separator is interposed between the positive electrode and the negative electrode, and a thin insulating film with high ion permeability and mechanical strength is used. The pore diameter of the separator is typically 0.01 to 10 micrometers, and the thickness is typically 5 to 300 micrometers. As such separators, for example, chemically resistant and hydrophobic olefin polymers such as polypropylene; sheets or non-woven fabrics made of glass fiber or polyethylene are used. When a solid electrolyte such as a polymer is used as an electrolyte, the solid electrolyte can also function as a separator.

The electrode assembly is not limited in its structure, and may be a laminated electrode assembly in which a positive electrode, a separator, and a negative electrode are pressed into a unit electrode and laminated, a jelly roll-type electrode assembly in which positive electrode sheets, separator, and negative electrode sheets are laminated and wound, or a stack-and-folding type electrode assembly in which unit electrodes are arranged on a sheet-shaped separation film and wound.

The battery case can be a pouch-type battery case made of aluminum laminate sheet, or a square or cylindrical battery case made of a metal can.

The electrolyte may include, but is not limited to, organic liquid electrolytes, inorganic liquid electrolytes, solid polymer electrolytes, gel-type polymer electrolytes, solid inorganic electrolytes, and molten inorganic electrolytes that can be used in the manufacture of lithium rechargeable batteries.

Specifically, the organic liquid electrolyte, i.e., the electrolyte, may include an organic solvent and a lithium salt.

Any organic solvent that can act as a medium through which ions involved in the electrochemical reaction of the battery can move can be used without any special restrictions. Specifically, the organic solvent may include:

Ester-based solvents, such as methyl acetate, ethyl acetate, γ-butyrolactone (GBL), and ε-caprolactone (ε-CL); Ether-based solvents, such as dibutyl ether and tetrahydrofuran (THF); Ketone-based solvents, such as cyclohexanone; Aromatic hydrocarbon solvents, such as benzene and fluorobenzene; Carbonate-based solvents, such as dimethyl carbonate (DMC), diethyl carbonate (DEC), methyl ethyl carbonate (MEC), ethyl methyl carbonate (EMC), ethylene carbonate (EC), and propylene carbonate (PC); Additional ether solvents, such as dimethoxyethane (DME), diethyl ether, ethylene glycol dimethyl ether (EGDME), and tetraethylene glycol dimethyl ether (TEGDME); Dioxolanes, such as 1,3-dioxolane (DOL); Furans, such as 2-methyltetrahydrofuran (2MeTHF); Alcohol solvents, such as ethanol and isopropyl alcohol (IPA); Nitriles, represented by R—CN (where R is a C₂-C₂₀ hydrocarbon group, linear, branched, or cyclic, and may include double bonds or ether linkages); Amides, such as dimethylformamide (DMF); Sulfolanes, and the like. Among these, a carbonate solvent or an ether solvent is preferable, and a mixture of a cyclic carbonate (e.g., ethylene carbonate or propylene carbonate, etc.) with high ion conductivity and high dielectric constant that can improve the charging and discharging performance of the battery; and a low-viscosity linear carbonate compound (e.g., ethylmethyl carbonate, dimethyl carbonate, or diethyl carbonate, etc.); is more preferable. In this case, cyclic carbonate and linear carbonate can be mixed and used in a volume ratio of about 1:1 to about 1:9 to achieve excellent electrolyte performance.

A mixture of linear ethers (e.g., dimethoxy ether, ethylene glycol dimethyl ether, etc.) with excellent reduction stability and cyclic dioxolane can also be used to improve the reversible charging and discharging performance of lithium metal.

The lithium salt can be used without any special restrictions as long as it is a compound that can provide lithium ions used in a lithium rechargeable battery. Specifically, the lithium salt may be LiPF₆, LiClO₄, LiAsF₆, LiBF₄, LiSbF₆, LiAl0₄, LiAlCl₄, LiCF₃SO₃, LiC₄F₉SO₃, LiN(C₂F₅SO₃)₂, LiN(C₂F₅SO₂)₂, LiN(CF₃SO₂)₂. LiCl, LiI, or LiB(C₂O₄)₂ may be used. The concentration of the lithium salt can be used within the range of 0.1M to 2.0M or within the range of 2.0M to 6.0M. When the concentration of lithium salt is in the range of 0.1 M to 2.0 M, the electrolyte can exhibit excellent electrolyte performance because it has appropriate conductivity and viscosity, and lithium ions can move effectively. When the concentration of lithium salt is in the range of 2.0M to 6.0M, the transfer number of lithium increases, so that lithium ions move effectively, and all electrolyte solvents are coordinated to the lithium salt, so that the oxidation and reduction stability of the electrolyte solvent are improved, and the corrosion of lithium metal and current collector can be suppressed.

In addition to the electrolyte components, the electrolyte may further contain one or more additives, such as haloalkylene carbonate compounds such as difluoro ethylene carbonate, pyridine, triethylphosphite, triethanolamine, cyclic ether, ethylene diamine, n-glyme, hexaphosphate triamide, nitrobenzene derivative, sulfur, quinone imine dye, N-substituted oxazoleridinone, N,N-substituted imidazoleridine, ethylene glycol dialkyl ether, ammonium salts, pyrrole, 2-methoxy ethanol or trichloro-aluminum, for the purpose of improving the life-span characteristics of the battery, suppressing battery capacity decrease, and improving the discharge capacity of the battery.

However, the above contents are only examples of components and methods generally known in the industry, and can be modified in any way according to the technical common sense of a person of an ordinary skill in the art.

The lithium metal rechargeable battery of the embodiment can also be provided as a battery module including the unit cell and a battery pack including the unit cell.

The battery module or battery pack can be used as a power source for one or more medium-to large-sized devices, including a power tool; an electric vehicle (EV), a hybrid electric vehicle, and a plug-in hybrid electric vehicle (PHEV); or an electric power storage system.

Below, some embodiments is described in detail so that a person of ordinary skill in the technical field to which the present disclosure belongs can easily carry out the present disclosure. As those skilled in the art would realize, the described embodiments may be modified in various different ways, all without departing from the spirit or scope of the present disclosure.

### Embodiment 1

### (1) Preparation of Positive Electrode for Lithium Metal Rechargeable Battery

The slurry for the electrode manufacturing was prepared by mixing the manufactured positive electrode active material (Li(NiMnCo)₂): conductive material (carbon nanotube): binder (PVDF, MW 10,000 Da)=98.0:0.5:1.5 wt % with NMP (N-Methyl-2-pyrrolidone). The manufactured slurry was applied onto an Al foil with a thickness of 20 μm using a bar coater. Afterwards, a coating solution containing 2.0 wt % of polyethylene oxide (PEO), an ion-conductive polymer, mixed in NMP (N-Methyl-2-pyrrolidone) was applied to the upper part of the manufactured unrolled current collector, vacuum-dried at 130° C. for 12 hours, and then rolled.

### (2) Preparation of Lithium Metal Rechargeable Battery

As a negative electrode, metal lithium was deposited (thickness: 100 μm) on a current collector (thickness: 20 μm) made of copper to manufacture a lithium metal negative electrode sheet, and the lithium metal negative electrode sheet was stamped to form a negative electrode.

A lithium metal rechargeable battery was manufactured using the positive electrode and negative electrode manufactured in embodiment 1-1, a polyethylene film (Celgard, thickness: 20 μm) as a separator, and an electrolyte in which LiPF6 is dissolved at a concentration of 1 M in a solvent mixed with ethylene carbonate: dimethylethylene carbonate:diethyl carbonate=1:2:1 and housed in a pouch-type case.

### Embodiment 2

The positive electrode was manufactured in the same manner as in embodiment 1, except that a coating solution containing 5 wt % of the ion-conductive polymer, polyethylene oxide (PEO), was used in NMP (N-Methyl-2-pyrrolidone).

### Comparative Example 1

The positive electrode was manufactured in the same manner as in embodiment 1, except that a coating solution containing 1 wt % of the ion-conductive polymer, polyethylene oxide (PEO), was used in NMP (N-Methyl-2-pyrrolidone).

### Comparative Example 2

The positive electrode was manufactured in the same manner as in embodiment 1, except that a coating solution containing 7 wt % of the ion-conductive polymer, polyethylene oxide (PEO), was used in NMP (N-Methyl-2-pyrrolidone).

### Comparative Example 3

The positive electrode was manufactured in the same manner as in embodiment 1, except that a coating solution containing 10 wt % of polyethylene oxide (PEO), an ion-conductive polymer, was used in NMP (N-Methyl-2-pyrrolidone).

### Comparative Example 4

The positive electrode was manufactured in the same manner as in embodiment 1, except that the coating solution containing a mixture of polyethylene oxide (PEO) and NMP (N-Methyl-2-pyrrolidone) was not used.

### Comparative Example 5

When manufacturing the positive electrode, the method was the same as embodiment 1, except that the coating solution containing a mixture of polyethylene oxide (PEO) and NMP (N-Methyl-2-pyrrolidone) was not used, and 1.5 wt % of polyethylene oxide (PEO) was mixed in the slurry and sufficiently dissolved.

### Comparative Example 6

When manufacturing the positive electrode, the method was the same as embodiment 1, except that the coating solution containing a mixture of polyethylene oxide (PEO) and NMP (N-Methyl-2-pyrrolidone) was not used, and 7.5 wt % of polyethylene oxide (PEO) was mixed in the slurry and sufficiently dissolved.

### Comparative Example 7

When manufacturing the positive electrode, the method was the same as in embodiment 1, except that the coating solution containing a mixture of polyethylene oxide (PEO) and NMP (N-Methyl-2-pyrrolidone) was not used, and 30 wt % of polyethylene oxide (PEO) was mixed in the slurry and sufficiently dissolved.

### Experimental Example 1: Scanning Electron Microscope (SEM) Evaluation

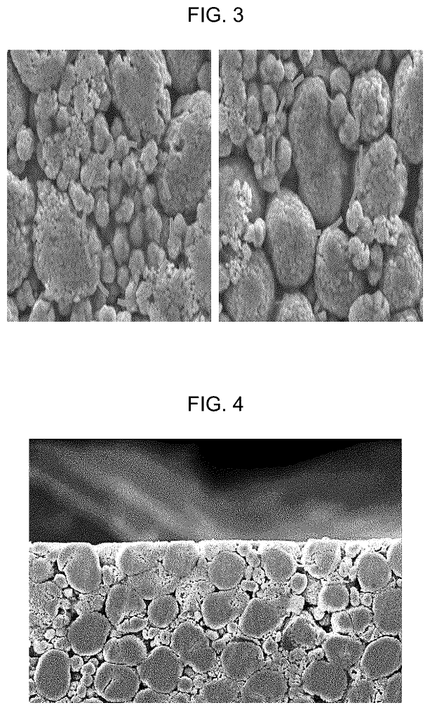

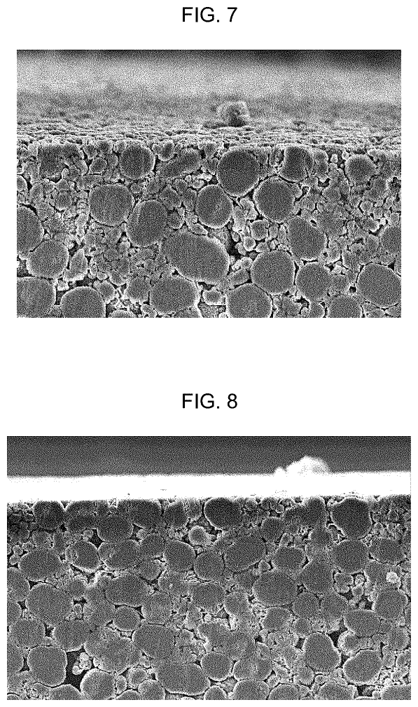

Scanning electron microscope (SEM) images of the positive electrodes for lithium metal rechargeable batteries manufactured according to Examples 1 to 4 and Comparative Examples 1 and 4 were observed, and the results are shown in FIGS. 2 to 10.

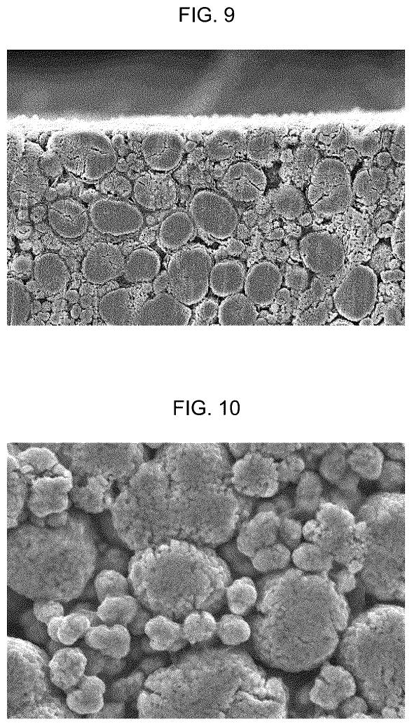

Referring to FIGS. 2 to 7, it was confirmed that the active material on the upper part of the positive electrode coated with polyethylene oxide (PEO) of embodiments 1 to 3 showed improved breakage of the positive electrode active material particle compared to Comparative Example 1. In addition, when examining the scanning electron microscope (SEM) images of the initial and end-of-life (EOL) states of Comparative Example 1, which were not coated with polyethylene oxide (PEO) of FIGS. 8 and 9, the breakage of the positive electrode active material particle on the top of the positive electrode was clearly observed, and the electrolyte decomposition residue could be visually confirmed.

### Experimental Example 2: Resistance (ohm·cm) Evaluation

The resistance (ohm·cm) of the positive electrode for a lithium metal rechargeable battery manufactured according to embodiments 1 and 2 and Comparative Examples 1 to 7 was evaluated, and the results are shown in Table 1 below.

### Experimental Example 3: Adhesive Strength (N/2 cm) Evaluation

The adhesive strength (N/2 cm) of the positive electrode for a lithium metal rechargeable battery manufactured according to embodiments 1 and 2 and Comparative Examples 1 to 7 was evaluated, and the results are shown in Table 1 below.

### Experimental Example 4: Life-Span Characteristic Evaluation

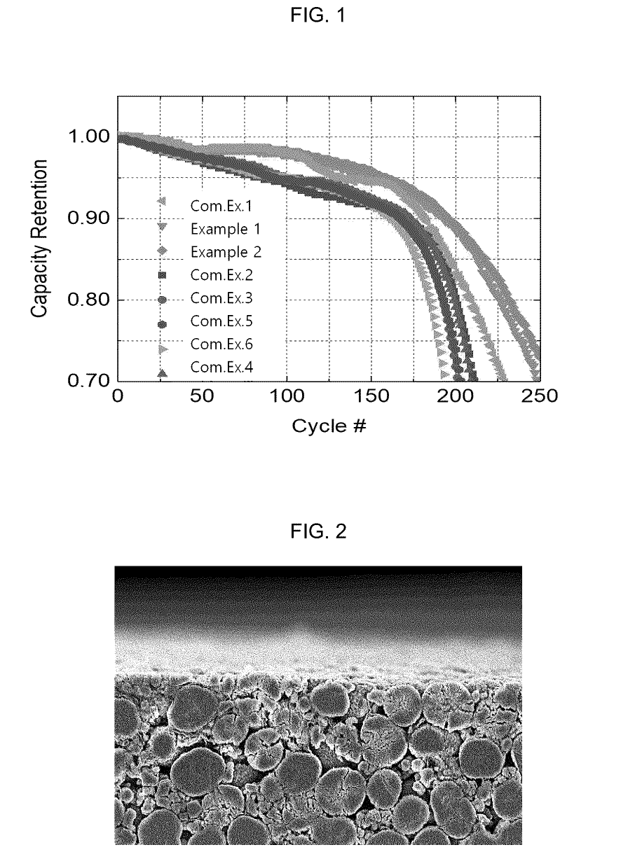

After fabricating a lithium metal rechargeable battery half-cell, it was charged to 4.25 V at a constant current of 0.33 C at 25° C., then switched to a constant voltage and charged until the end current reached 0.05 C. After a 10-minute rest time after charging, discharge was performed at a constant current of 0.33 C until reaching 2.5 V. Charging and discharging were performed 200 times under the above charge and discharge cycle conditions, and the capacity retention rate of the 200th cycle compared to the first cycle was calculated, and the results are shown in Table 1 and FIG. 1 below.

TABLE 1

| | PEO | PEO/ | | adhesive | life- |
|---|---|---|---|---|---|
| | concentration | PVDF in | Resistance | strength | span (200 |
| | (wt %) | slurry | (ohm · cm) | (N/2 cm) | cycle, %) |
| embodiment 1 | 2 | — | 23 | 0.6 | 88.5 |
| embodiment 2 | 5 | — | 24 | 0.6 | 89.3 |
| Comparative | 1 | — | 20 | 0.6 | 83.3 |
| Example 1 | | | | | |
| Comparative | 7 | — | 28 | 0.5 | 80.2 |
| Example 2 | | | | | |
| Comparative | 10 | — | 35 | 0.4 | 71.8 |
| Example 3 | | | | | |
| Comparative | — | — | 20 | 0.6 | 79.1 |
| Example 4 | | | | | |
| Comparative | — | 1 | 28 | 0.5 | 73.9 |
| Example 5 | | | | | |
| Comparative | — | 5 | 32 | 0.5 | 60.0 |
| Example 6 | | | | | |
| Comparative | — | 20 | 54 | 0.2 | short |
| Example 7 | | | | | |

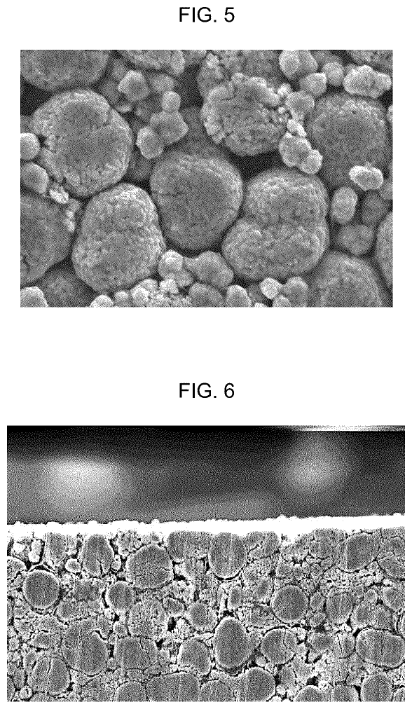

Referring to Table 1, the method of applying polyethylene oxide (PEO) on top of the positive electrode was introduced in embodiments 1 and 2, so that the resistance slightly increased depending on the concentration of polyethylene oxide (PEO), and the adhesive strength was maintained similarly to Comparative Example 4. However, referring to FIG. 1, when evaluating the life-span characteristics, it was confirmed that the life-span (200 cycles) of embodiments 1 and 2 increased. In addition, FIGS. 2 to 4 are scanning electron microscope (SEM) images of the upper portion of the positive electrode active material layer of embodiments 1 and 2, and it can be confirmed that the breakage of the positive electrode upper positive electrode active material is significantly reduced compared to the comparative examples of FIGS. 5 to 10. Also, in Comparative Example 2, when the concentration of polyethylene oxide (PEO) was high, the scanning electron microscope (SEM) image of FIG. 5 confirmed that the particle breakage of the positive electrode active material was improved, but the resistance increased, and the adhesive strength decreased slightly. This can be judged to be because the polyethylene oxide (PEO) was excessive enough to penetrate into the positive electrode current collector. In addition, in Comparative Example 3, it was confirmed that when the concentration of polyethylene oxide (PEO) in the coating solution was excessive, the resistance increased by more than 20%, and the life-span deteriorated accordingly. Referring to Comparative Examples 5 to 7, it was confirmed that when polyethylene oxide (PEO) was distributed throughout the positive electrode, the improvement in particle breakage was minimal, the resistance greatly increased, and the adhesive strength greatly decreased, as can be seen in FIG. 10. Therefore, when introducing a coating solution including polyethylene oxide (PEO) to the positive electrode for a lithium metal rechargeable battery in the present disclosure, it was confirmed that it was most effective to apply it to the positive electrode so that it was positioned only at the upper part and to introduce the optimal content. In addition, referring to embodiments 1 and 2, resistance, adhesive strength, and life-span were preferably implemented when the content of PEO in the coating solution was appropriately controlled. Through this, it was possible to predict effects such as improved breakage of positive electrode active material and improved battery characteristics when manufacturing positive electrode for lithium metal rechargeable batteries.

Although the present disclosure has been described above with regard to a preferably embodiment thereof, the present disclosure is not limited thereto, and it is possible to implement the present disclosure by modifying it in various ways within the scope of the patent claims and the detailed description and accompanying drawings of the disclosure, and this also naturally falls within the scope of the present disclosure.

Therefore, it can be said that the actual scope of the present disclosure is defined by the attached patent claims and their equivalents.

What is claimed is:

1. A positive electrode for lithium metal rechargeable battery, comprising:
a current collector;
a positive electrode active material layer formed on the current collector; and
a polymer-containing coating layer disposed on the positive electrode active material layer;
wherein the polymer-containing coating layer contains an ion-conductive polymer comprising an alkylene oxide segment.

2. The positive electrode of claim 1, wherein:
a content of the ion-conductive polymer is about 0.5 to 20 wt %, based on the total weight (100 wt %) of the positive electrode active material layer.

3. The positive electrode of claim 1, wherein:
the ion-conductive polymer comprises at least one selected from the group consisting of polyethylene oxide, polypropylene oxide, polybutylene oxide, polyethylene oxide-polypropylene oxide blend, polyethylene oxide-polybutylene oxide blend, polyethylene oxide-polypropylene oxide-polybutylene oxide block copolymer, and polymethylmethacrylate to which polyethylene oxide is grafted (PEO grafted PMMA).

4. The positive electrode of claim 3, wherein:
the ion-conductive polymer is polyethylene oxide.

5. The positive electrode of claim 1, wherein:
a weight average molecular weight (Mw) of the ion-conductive polymer is about 50,000 to 100,000 Da.

6. The positive electrode of claim 1, wherein:
the positive electrode active material layer comprises a positive electrode active material, a conductive material, and a binder.

7. The positive electrode of claim 1, wherein:
the positive electrode active material layer comprises a positive electrode active material represented by Liₐ[NiₓCo_{y}Mn_{z}M_{w}]O₂,
wherein 0.8≤a≤1.2, 0<x<1, 0≤y≤1, 0≤z≤1, 0≤w≤1, and x+y+z+w=1, and M is Zr, Al, B, Y, Mg, Ti, Nb, W, Sc, Si, V, Fe, Y, Mo, Ce, Hf, Ta, La, Sr or combination thereof.

8. The positive electrode of claim 6, wherein:
the positive electrode active material is about 80 to 99 wt %, based on the total weight (100 wt %) of the positive electrode active material layer.

9. The positive electrode of claim 6, wherein:
the conductive material is about 0.5 to 5.0 wt %, based on the total weight (100 wt %) the positive electrode active material layer.

10. The positive electrode of claim 9, wherein:
the conductive material comprises at least one selected from graphite, carbon black, acetylene black, and carbon nanotube.

11. The positive electrode of claim 6, wherein:
the binder is about 0.5 to 5.0 wt %, based on the total weight (100 wt %) the positive electrode active material layer.

12. The positive electrode of claim 1, wherein:
a porosity of the positive electrode is about 20 to 40%.

13. A method of manufacturing a positive electrode for lithium metal rechargeable battery, the method comprising:
preparing a coating solution containing an ion-conductive polymer comprising an alkylene oxide segment;
applying the coating solution on a positive electrode active material layer;
drying the coating solution; and
rolling the positive electrode.

14. The method of claim 13, wherein:
a content of polyethylene oxide, an ion-conductive polymer, in the coating solution is about 2 to 6 wt %.

15. The method of claim 13, wherein:
a solvent in the coating solution comprises at least one selected from methylpyrrolidone, dimethyl formamide, ethanol, acetone, diethyl ether or ethylacetate.

16. The method of claim 13, wherein:
the step of applying a coating solution on the positive electrode active material layer is applying it using a bar coater.

17. The method of claim 13, wherein:
the coating solution is dried at about 70 to 130° C.

18. The method of claim 13, wherein:
the positive electrode is rolled to a rolling density of about 2.0 to 4.0 g/cc.

19. A lithium metal rechargeable battery, comprising the positive electrode, according to claim 1.

20. A vehicle comprising the lithium metal rechargeable battery of claim 19.
